(19) United States
(12) Patent Application Publication
(10) Pub. No.: US 2026/0192929 A1
(43) Pub. Date: Jul. 9, 2026

(54) VERTICAL AND SHORT TAKE-OFF AND LANDING LIFT BOOSTER SYSTEM

(71) Applicant: JETOPTERA, INC., Edmonds, WA (US)

(72) Inventor: Andrei Evulet, Edmonds, WA (US)

(73) Assignee: JETOPTERA, INC., Edmonds, WA (US)

(21) Appl. No.: 19/130,945

(22) PCT Filed: Nov. 21, 2023
(86) PCT No.: PCT/US2023/080798

§ 371 Date: May 17, 2025

Related U.S. Application Data
(60) Provisional application No. 63/427,043, filed on Nov. 21, 2022.

(51) Int. Cl. B64D 27/359; B64C 29/00; B64D 27/31; B64D 27/34; B64D 27/357

(52) U.S. Cl. CPC B64D 27/359; B64C 29/00; B64D 27/31; B64D 27/34; B64D 27/357

(57) ABSTRACT

A propulsion system for a vehicle includes at least one generator; at least one ultracapacitor coupled to the at least one generator; at least one battery coupled to the at least one generator; at least one compressor coupled to the at least one generator, the at least one ultracapacitor and the at least one battery; and at least one propulsive element coupled to the compressor.

### PRIORITY CLAIM

This application is a national stage entry from PCT Application No. PCT/US2023/080798 filed Nov. 21, 2023, which claims priority to U.S. Provisional Patent Application Ser. No. 63/427,043 filed Nov. 21, 2022, the contents of both are hereby incorporated by reference as if fully set forth herein.

### COPYRIGHT NOTICE

This disclosure is protected under United States and/or International Copyright Laws. © 2023 Jetoptera, Inc. All Rights Reserved. A portion of the disclosure of this patent document contains material which is subject to copyright protection. The copyright owner has no objection to the facsimile reproduction by anyone of the patent document or the patent disclosure, as it appears in the Patent and/or Trademark Office patent file or records, but otherwise reserves all copyright rights whatsoever.

### BACKGROUND

Existing VTOL and STOL propulsors have a major challenge in choosing the right size or power of the propulsion system because of the disparity between the power needed at take off versus the power needed at cruise. Some systems involve rotary wings or tilting rotors or ducted fans, vectoring jets or a combination thereof called compound helicopters, but they are of low lift-to-drag characteristics and do not have a high endurance, being also limited in speed. Aircraft such as the Harrier jump jet proved excellent in taking off and landing vertically, but its propulsion system was oversized for the cruise speed it could offer. The challenge of any VTOL aircraft is hence the propulsor of choice, usually ending up with a very large weight fraction of the entire aircraft, hence limiting payload and range and endurance. When a large turbine based system is sized for VTOL, and in cruise flight its operating point is far from the VTOL operating point, the turbine is only operating efficiently at, for example, take off, and conversely, less efficiently in cruise.

The propulsor for the current V/STOL aircraft in military or civilian application relies on tilting, large rotors, such as the V-22 Osprey or the Agusta AW609 or on large, fixed ducted fans such as the F-35 fighter jet. The challenge with the latter is that the fixed ducted fan becomes dead weight for 99% of the mission time, when in non-vertical flight segments. It is now known that the F35 no longer is called VTO but STOVL, given the fact that the weight displaced by the vertical take off fan limits the aircraft only to land vertically, when fuel was consumed during the mission and the aircraft is lighter and able to vertically land for the power available onboard. This limits also the payload capabilities, it is very complex and unaffordable for smaller, manned or unmanned applications. The challenge with the V22 rotors is that they are of large footprint, must tilt with high precision yet they still limit the maximum speed due to the limitations of the tip speed of the rotors. The V22 history of development has also shown it has critical flaws that cost a lot of lives. A high-speed enabling VTOL propulsor is needed, one that can propel an aircraft at high speeds or high endurance typical of Intelligence, Surveillance and Reconnaissance. Most eVTOL aircraft employ tilting, multiple propellers that are very efficient but they depend on very heavy batteries, many times lower in energy density than jet fuel. Many of the hundreds of the eVTOL platforms proposed use fixed propellers, multiple, distributed for the vertical take-off and a single pusher propeller for horizontal flight, and they are severely limited in speeds as well. It is therefore clear that there is a need for a novel approach of propulsion that optimizes the operation when in cruise conditions, is lighter than both the battery operated vehicles or the oversized for VTOL turbines.

While engineers are implementing sophisticated and high-cost technologies to enable propellers to maximize their hovering efficiency, present day smaller propellers are suffering from low efficiencies and high costs. The speeds for cargo drones and Urban Air Mobility flying cars (air taxis) are limited to low values, the propellers are noisy and inefficient at those sizes.

Most hybrid V/STOL aircraft may use a hybrid system called range extending systems, in comparison with the very strict limitation in range and endurance typically suffered by all electric aircraft. Again, this is due to the fact that massive batteries are needed for these aircraft and it is viewed that a hybrid system involving a generator is hence extending the range of an eg eVTOL by doubling it. It is, however true that even when sizing the generator onboard producing the electric power that feeds electric motors spinning fans or propellers, the impact on the aircraft is still more detrimental than a purely fuel to propulsion system, due to the additional elements that need to be added to the legacy system. The generator usually needs an invertor, a conditioner, cooling, large cables, electric power transmission, electronics and may still need a battery, making the entire hybrid system as one specialist mentioned “three times more expensive, twice as heavy and overall 10% less efficient.” This results from the fact that by adding additional components themselves far from being 100% efficient, the thermal efficiency of the powerplant is degraded significantly and the propulsor becomes heavier, less efficient and costlier to maintain and to operate, not to mention that it displaces the useful payload with components that didn't exist in the legacy system.

In addition, the power boost needed for V/STOL aircraft is typically a very small fraction of the entire mission, most likely at the beginning and the end, making the decision even more difficult in choosing the right propulsion and energy storage combination. For instance, a VTOL aircraft may only need to operate in hover or vertical take off or landing for 1-2 minutes, whereas it is desired to fly in cruise conditions (or wingborne) for hours at the time.

It is therefore of interest to create an architecture that allows for a V/STOL aircraft to operate efficiently at cruise using a generator that is highly efficient operating at its highest efficiency point but benefit from some augmentation power for of lift production in the vertical phase of the mission without addition of heavy and poor energy density systems such as batteries, motors and the auxiliary systems. Such a system would in effect optimize the operation of any V/STOL aircraft significantly.

### BRIEF DESCRIPTION OF THE DRAWINGS

FIG. 1 is a schematic illustration of a Hybrid Vertical Take Off and Landing System according to an embodiment;

FIG. 2 illustrates the operation during Vertical Take Off according to an embodiment;

FIG. 3 illustrates the operation during transition to wingborne according to an embodiment;

FIG. 4 illustrates the operation during wingborne according to an embodiment;

FIG. 5 illustrates the operation during wingborne bypassing the battery usage while recharging the battery according to an embodiment;

FIG. 6 illustrates an alternative wingborne operation using an electric ducted fan according to an embodiment; and

FIG. 7 illustrates an alternative wingborne operation using an electric driven propeller according to an embodiment.

### DETAILED DESCRIPTION OF THE PREFERRED EMBODIMENT

This application is intended to describe one or more embodiments of the present invention. It is to be understood that the use of absolute terms, such as “must,” “will,” and the like, as well as specific quantities, is to be construed as being applicable to one or more of such embodiments, but not necessarily to all such embodiments. As such, embodiments of the invention may omit, or include a modification of, one or more features or functionalities described in the context of such absolute terms. In addition, the headings in this application are for reference purposes only and shall not in any way affect the meaning or interpretation of any embodiment of the present invention.

Embodiments of the present invention disclosed in this application relate to an augmenting propulsive system that specifically operates in conjunction with an electric motor powering an air compressor, fan or propeller. Rather than sizing the propulsion system of an aircraft 100 to produce a maximum force at least 20% more than the weight of the aircraft system for vertical take off and hence resulting in a larger propulsor in weight at cruise conditions, the approach involves the use of electric ultracapacitors or supercapacitors that can deliver a massive amount of power in a short time, hence being able to power additionally the electric components onboard said aircraft sufficiently to lift the aircraft off the ground or land it vertically. A supercapacitor (SC), also called an ultracapacitor, is a high-capacity capacitor with a capacitance value much higher than other capacitors, but with lower voltage limits, and that bridges the gap between electrolytic capacitors and rechargeable batteries. Unlike ordinary capacitors, supercapacitors do not use the conventional solid dielectric, but rather, they use double-layer capacitance on one electrode and electrochemical battery electrode as the other.

One or more embodiments include a novel hybrid method of propulsion that can be employed without the shortcomings of the propellers. The propulsor is designed from the principles of thrust augmentation using special ejectors and Upper Surface Blown lift augmentation. Such ejectors may include those disclosed in U.S. Prov. Patent Appl. 62/213,465 filed Sep. 2, 2015 and U.S. patent application Ser. No. 15/256,178 filed Sep. 2, 2016, each of which is hereby incorporated by reference as if fully set forth herein. The air supply may come from, for example, an electric turbo-compressor, an electric turbofan or any electric air compressor that produces at least a 1.5:1 pressure ratio supply of air in sufficient quantities and is operated electrically by at least two sources: a generator and a series of ultracapacitors or supercapacitors

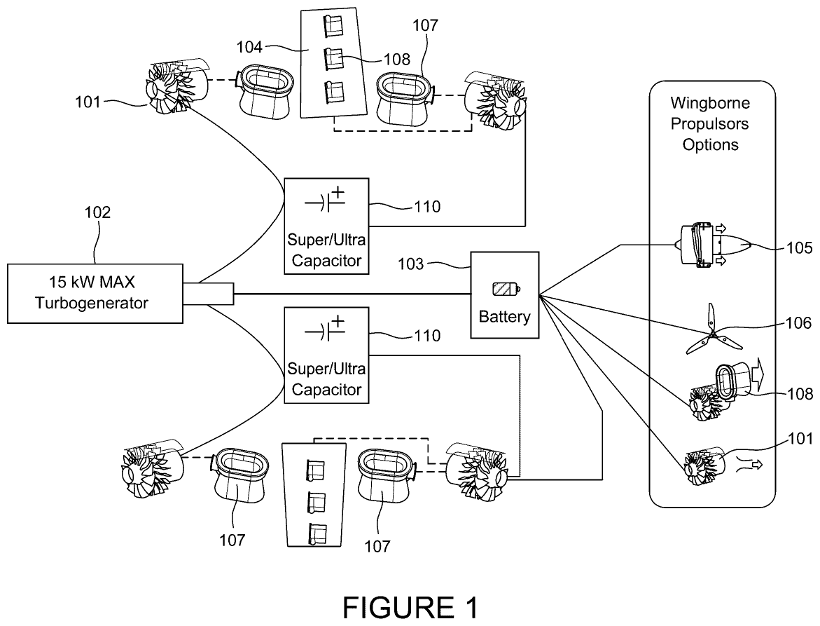

In FIG. 1, which illustrates the VTOL configuration of an embodiment of the present invention, compressed air is produced by air compressors 101. These compressors 101 may be electric turbofans bypass air stream or any type of fan or compressor that can produce a large amount of flow at specifically at least 1.5 pressure ratio to ambient pressure. The air compressed by the compressor 101 may be routed to wingborne ejectors 108 and/or may be used for other purposes, including being directed into the intake of the secondary nozzle or used for cooling, augmentation of thrust, cabin pressurization, or other uses. In varying embodiments, wingborne ejectors 108 may be positioned on or embedded in an aerodynamic surface such as wing 104. As with typical turbocharger compressors, the compressor 101 may have at peak operation a pressure ratio of preferably 2.5 or more. A valve may be present on the compressor discharge volute to direct the compressed air to either the secondary compressor or outside the gas generator, as need may be.

The electric power supplied to the electric compressors 101 is provided in part by a generator 102 that is sized for the cruise condition of the aircraft. If, for example, the cruise need is 1/2 of the power needed at takeoff, then the generator 102 is sized precisely at that power rating, producing the optimal power at the optimal operating point throughout the mission.

The rest of the electric power needed for takeoff, hover or vertical landing, or any time the compressors 101 are required to boost the propulsion is provided by a series of ultra or supercapacitors 110, which are far more capable of electric power production in short bursts and at high currents and voltage for a limited duration than a battery is. The advantage of these ultracapacitors 110 is also their ability to rapidly recharge in flight in a matter of minutes, from the said generator 102. By sizing the system right, the aircraft 100 can operate extremely efficiently with rapid vertical take off and landing and may even hover for minutes, without the burden of a large battery that cannot provide the large power needed by these flight instances, without the danger of thermal runaways or severe heat management issues that those familiar with the matter understand.

In one embodiment the aircraft 100 is a small unmanned system of 350 lbs weight carrying a payload of e.g., 60 lbs and fuel for 110 lbs, the generator 102 is producing, for example, constantly 15 kWe with high efficiency, being a thermally regenerative gas turbine or a very high efficiency piston engine, and weighs 70 lbs. Three ultracapacitors 110 weighing not more than 45 lb are providing for up to 2 minutes of a total of 90 kWe that supplies the balance of power needed for all the motors driving the compressors, fans or propellers dedicated to vertical take off and landing phases of flight. This, in turn, provides the sufficient thrust to an aircraft to take off or land vertically. The generator 102 can always stay “on” to provide the 15 kWe power required for forward flight (or wingborne flight) when all the thrust needed is to overcome the drag, and lift is generated mainly by the wing 104. In addition, the generator 102 can provide the electric power to perform various functions onboard, from navigational and communication, to aircraft control to servos and payloads, etc. The 350 lb aircraft has large wings enabling a lift-to-drag coefficient of 20 for a forward speed of only 30 knots, with the drag produced at this speed being only 350 lb÷20=17.5 lbf; this could be overcome by using an electric compressor producing a jet of 18 lbf at a modest pressure ratio of 1.1 supplied to an ejector with an augmentation ratio of 2.5 and consuming only 5 kWe. With increasing speed, and an L/D of e.g. 25, the power requirement is hence minimized and the turbogenerator can provide propulsion means to the system extending the range and endurance, provide recharging means for the ultracapacitors, provide power to the aircraft for controls, communication, navigation etc. and the payload, while only burning a minuscule mount of fuel for example for an output of only 10 kWe total and—in case it is a highly efficient, recuperative type of turbine generator, 0.6 lb/HP/h or 0.365 kg/kW/h, so the aircraft can fly in wingborne flight for a significant time, e.g. 100 lb fuel÷(0.6 lb/HP/h×13.4 HP)=12.4 hours, conservatively speaking, because the aircraft is getting lighter as it burns fuel. If using the Breguet equation for range, assuming a speed of 100 knots true and using up 100 lbs of fuel onboard the aircraft, for a L/D of 25, the endurance resulting is over 15 hours. The generator's output will be the equivalent of 13.4 HP (or 10 kWe) for the duration of the wingborne flight, allowing a remarkable endurance flight for a small aircraft with sufficient power for significant communication, of almost 16 hours and 1900 miles.

It is to be noted that if a battery is used in lieu of the ultracapacitors 110, with an energy density of 150 Wh/kg, with the need to supply 45 kWe over a few minutes, the weight imposed upon the vehicle for battery alone would be over 200 lbs, heavier than the generator 102 itself and not fitting in a 350 lbs system where the generator and battery combined weigh 77% of the gross weight of the aircraft. It would be impossible to discharge the battery in a rapid sequence as the chemistry inside the battery would be accelerated to a point the battery may be rendered useless or even explode. Only a large mass of battery would be capable of providing such boost in power consumption for a brief time to take off, but that would impose the vehicle's weight to increase significantly and likely, not offering a solution. The battery would also be subject to two orders of magnitude longer times to recharge than ultracapacitors need. This is why the hybrid system using capacitors and ultracapacitors is uniquely enabling V/STOL as well as other applications.

In another embodiment VTOL ejectors 107, which may be rotatable through 360°, are used for VTOL, supplied with air from an electric compressor 101 powered by the ultracapacitors 110, for a few minutes. By the time the aircraft 100 is in wingborne flight, the ultracapacitors 110 no longer provide power and only the turbogenerator 102 is powering a single forward flight propulsor that may be a propeller, a fan, an ejector or a combination thereof.

In another example 1 lb/s motive air flow is produced using a compressor such as the ones typically employed in turbochargers or electric compressors, operating at a maximum pressure ratio of 2.0:1 and at isentropic efficiencies of exceeding 85%; in this case the input mechanical or electrical power need to drive the air compressor is 38 horse power (HP) or about 29 kW; this motive air is supplied to Fluidic Propulsive Systems deployed on a wing or around the fuselage, in effect thrusters-ejectors, when deployed at the correct angle of tilt and across the wing in a Upper Surface Blown configuration over the deployed flaps, the lift force generated at speeds as low as 10 knots is doubled, compared to the case where a clean wing is used at the same head wind velocity (10 knots) but no thruster augmentors are active or present. This would allow the aircraft to perform super-short take off and landings (SSTOL) or eventually take off vertically in headwinds as for example on the deck of a ship placed into the wind. Typical values of lift force that can be obtained with the blown wing example in 10 knots head wind conditions and flaps deployed could be around 200 lbf for 38 HP input, resulting in a ratio of 5.26 lbf/HP, which is a common value for the hovering efficiency of a tilt rotor such as the V22 Osprey or a helicopter as explained by Maiselet al.—NASA SP-2000-4517, “The History of the XV-15 Tilt Rotor Research Aircraft:

From Concept to Flight“ (Bibliographic data) https://ntrs.nasa.gov/search.jsp? R=20000027499 (PDF) http://history.nasa.gov/monograph17.pdf.

It follows that an aircraft may be able to produce a vertical thrust of multiples of e.g., 200 lbf in low-speed headwinds by employing multiples of 38 HP electric compressors which may be powered by electrical ultracapacitors or supercapacitors, in addition to an electric generator minimized for the cruise condition which also is a source of recharging the ultracapacitors, in flight. A 380 HP load directed to the electric compressors distributed across an aircraft and powered by a combination of an Auxiliary Power Unit plus light weight ultracapacitors may hence produce, in combination with the fluidic thruster augmentors and the flaps of the blown wing, a vertical force of 2000 lbf by employing a motive air stream of 10 lb/s at a pressure ratio of 1.8 to ambient with an APU sized for only e.g. 120 HP (90 kW) and weighing less than 150 lbs, with an additional 260 HP (200 kW) from ultracapacitors that weigh 100 lbs, for a brief period of time, sufficient however to take off or land vertically. For a permanent battery onboard doing the same job, a 500 lb battery would be needed to provide 200 kW and not over such a short time.

It would be then advantageous that once airborne and gaining forward speed, the ultracapacitors are immediately recharged.

The system as shown in FIG. 1 has a generator 102 that supplies electric power to several elements: electric motors, payload, navigational, communication, controls and ultracapacitors 110 sized for a VTOL aircraft. The turbogenerator 102 is a 15 kWe maximum output operating optimally at full load and being preferably of regenerative type with efficiencies as high as 30%. This turbogenerator 102 could also be of piston engine generator type or any other generator that minimizes weight and maximizes efficiency, operating on preferably jet fuel, diesel or any other preferred fuel, including hydrogen. The generator 102 can be connected electrically to a series of electric compressors 101, a battery 103 for buffer, and a series of ultra or super capacitors 110. The battery 103 may also connect to other components such as servos, or wingborne propulsors such as an Electric Ducted Fan 105, an electric motor driving a propeller 106, another compressor 101 that feeds air to a thruster ejector 108 or an electric compressor 101 that may be used in dual roles, with feeding air to an ejector or simply expanding the air compressed to the ambient in shape of a jet. Ejectors 108 may also be employed in conjunction with a wing 104, augmenting wing at take off or in general, ejectors 108. At take off, the generator produces 15 kWe and the capacitors deliver another 90 kWe for only a few seconds up to a few minutes. After the aircraft has transitioned to forward flight (aka wingborne flight) all power from the ultracapacitors 110 is cut and for propulsion, the turbogenerator 102 only feeds one of the wingborne propulsor motors with electric power according to the need of thrust. A propeller 106 driven by an electric motor would be least consuming of energy, allowing very high endurance but very noisy and easily detected from far away. An Electric Ducted Fan 105 is least efficient but more silent from distance, producing only high frequency noise that is quickly absorbed at distance. A lower noise may be produced if the combination of a compressor embedded into the aircraft and muffled is used in conjunction with an ejector 108 of FPS type making the propulsor efficient and silent without peaks of noise frequencies but more like the wind, broadband noise only. One, some or all of these options may be employed on a vehicle, as needed, while ultracapacitors can be recharged in a matter of seconds.

In another embodiment, a hybrid propulsion system as described is utilized for a Super Short Take Off and Landing aircraft, much like Rocket Assisted Take Off (RATO) or Jet Assisted Take Off (JATO) are used for 10-30 seconds at the time, with the difference that the ultracapacitors can be used for the same time but cleaner, boosting lift, then recharged onboard while in flight, and used again in thousands of cycles. Rockets used for JATO and RATO are one use only. In this embodiment compressors can be embedded in the wing and close to ejectors such as FPS ejectors and working with the wing for a boost that puts the aircraft in the air sooner, cleaner and faster via FPS and Upper Surface Blown Wing. Lift coefficients can be significantly increased to double digit levels and the process is repeated until the aircraft is climbing very high, thanks to the ability to recharge said ultracapacitors for thousand of times, repeatedly and within seconds.

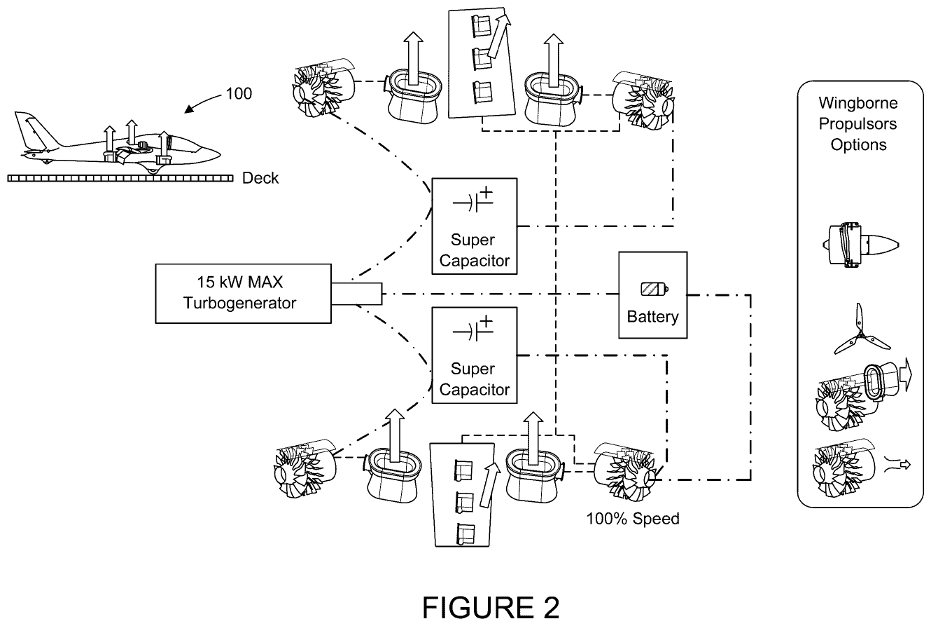

FIG. 2 illustrates operation during Vertical Takeoff of an aircraft 100 according to an embodiment. In such a configuration, compressors 101 receive electric power from at least one of generator 102, capacitors 110 and battery 103. The powered compressors 101, in turn, provide compressed air to VTOL ejectors 107, which are configured and oriented in such a way as to provide thrust and lift to aircraft 100 to facilitate vertical takeoff.

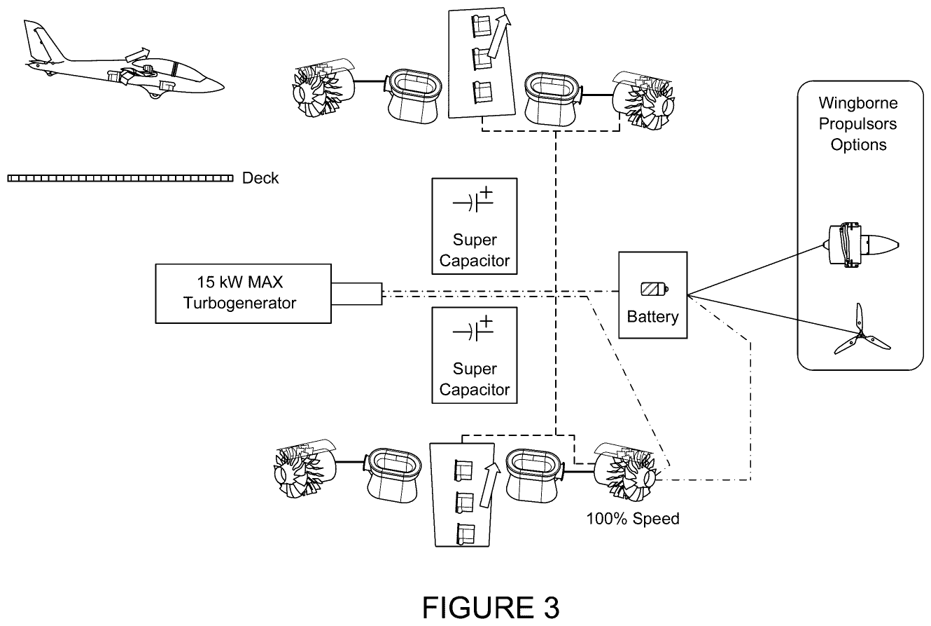

FIG. 3 illustrates operation during transition of aircraft 100 to a wingborne configuration according to an embodiment. In such a configuration, the ultracapacitors 110 no longer provide power and only the turbogenerator 102 and/or battery 103 powers one or more forward flight propulsors that may be, for example, propeller(s) 106, fan(s) 105, wingborne ejector(s) 108 or a combination thereof. In the example illustrated in FIG. 3, the powered forward flight propulsor(s) is/are wingborne ejector(s) 108 receiving compressed air from one or more compressors 101, which can be powered by generator 102 and/or battery 103.

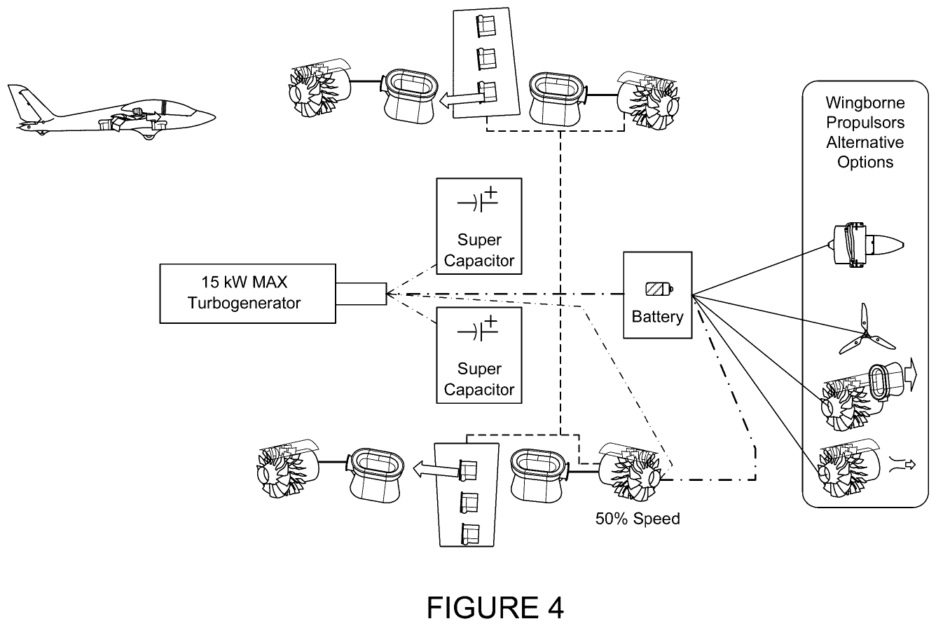

FIG. 4 illustrates wingborne operation of aircraft 100 according to an embodiment. In such a configuration, the ultracapacitors 110 no longer provide power and only the turbogenerator 102 and/or battery 103 powers one or more forward flight propulsors that may be, for example, propeller(s) 106, fan(s) 105, wingborne ejector(s) 108 or a combination thereof. In the example illustrated in FIG. 4, the powered forward flight propulsor(s) is/are wingborne ejector(s) 108 receiving compressed air from one or more compressors 101, which can be powered by generator 102 and/or battery 103. Additionally, ultracapacitors 110 are recharged by turbogenerator 102.

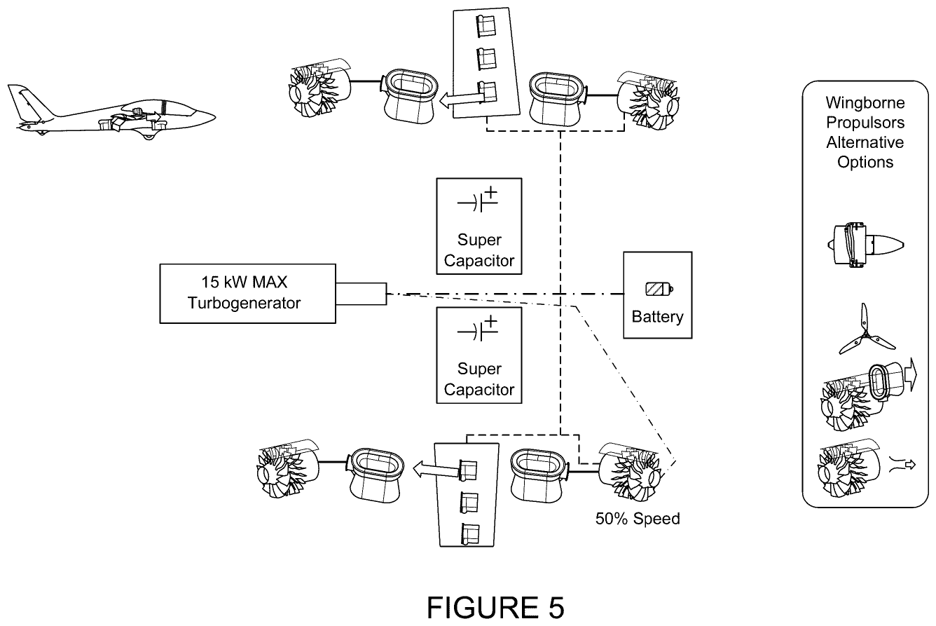

FIG. 5 illustrates wingborne operation of aircraft 100 with bypassing of battery usage while recharging the battery according to an embodiment. In such a configuration, the ultracapacitors 110 no longer provide power and only the turbogenerator 102 powers one or more forward flight propulsors that may be, for example, propeller(s) 106, fan(s) 105, wingborne ejector(s) 108 or a combination thereof. In the example illustrated in FIG. 5, the powered forward flight propulsor(s) is/are wingborne ejector(s) 108 receiving compressed air from one or more compressors 101, which can be powered by generator 102. Additionally, battery 103 is recharged by turbogenerator 102.

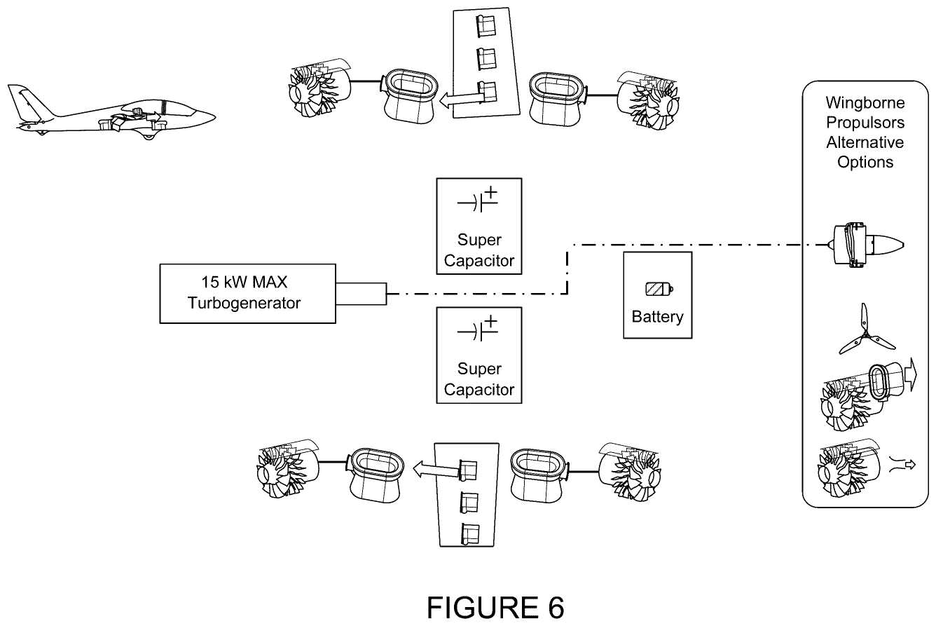

FIG. 6 illustrates an alternative wingborne operation of aircraft 100 using electric ducted fan 105 according to an embodiment. In such a configuration, the ultracapacitors 110 no longer provide power and only the turbogenerator 102 powers one or more fan(s) 105.

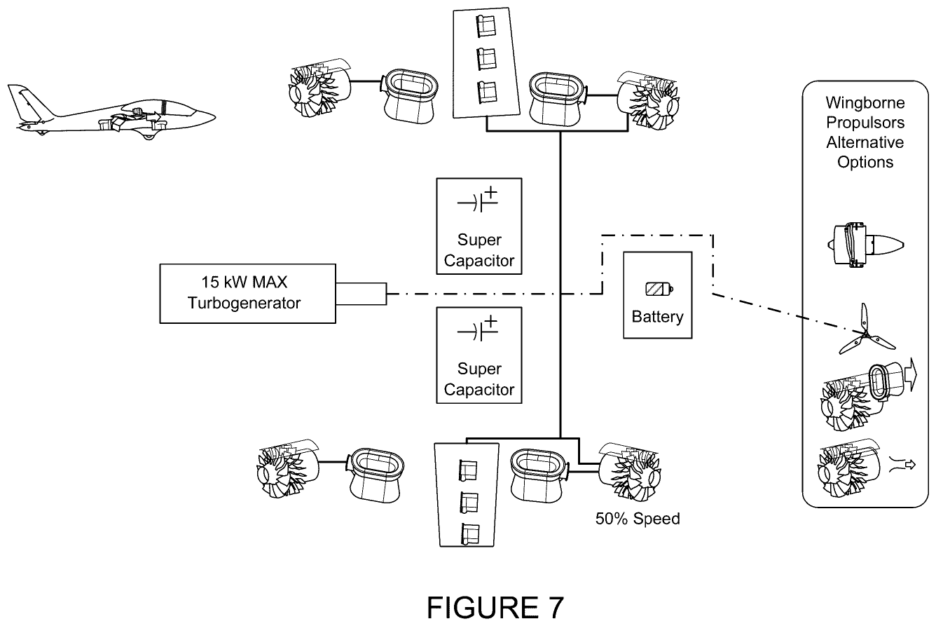

FIG. 7 illustrates an alternative wingborne operation of aircraft 100 using electric driven propeller 106 according to an embodiment. In such a configuration, the ultracapacitors 110 no longer provide power and only the turbogenerator 102 powers one or more propellor(s) 106.

One or more embodiments include a hybrid electric system that consists of a combination of generators and ultracapacitors which combined produce a large supply of electric power to an aircraft electric propulsor.

In one or more embodiments the generators and ultracapacitors are supplying alternatively power to several types of electric propulsors onboard of aircraft in a distributed arrangement.

One or more embodiments include a propulsion system comprising:
at least one generator, an ultracapacitor and a battery connected to electrical motors; at least one electric compressor, a conduit, a thrust augmentation device and a valve with a nozzle; at least an electric motor directly connected to at least a propeller; and at least an electric motor that powers at least a fan or rotor.

In one or more embodiments the ultracapacitors supply power for a limited time, then recharge from the said generator.

In one or more embodiments the ultracapacitors supply power for a limited time, then recharge from the said generator's starter battery.

One or more embodiments include a method of flying an aircraft or hovercraft comprising: maximizing the electric supply maximum power several thrust producing devices using electric motors and balancing the attitude of the aircraft by electrically powering and modulating power to thrust devices and for vertical hovering, take-off and landing for as long as capacitors can supply power; reverting to electric power from generator only when capacitors are depleted and recharging said capacitors while aircraft is in horizontal flight.

One or more embodiments include a method of flying an aircraft or hovercraft comprising: maximizing the electric supply maximum power several thrust producing devices using electric motors and balancing the attitude of the aircraft by electrically powering and modulating power to thrust devices and for short take-off for as long as capacitors can supply power, boosting the lift for shorter take off; reverting to electric power from generator only when capacitors are depleted and recharging said capacitors while aircraft is in horizontal flight; using said capacitors for boosting lift or thrust by burst powering motors driving the propulsors in flight for changing the attitude, speed and altitude of the aircraft and rapid maneuvering; maximizing the electric supply maximum power several thrust producing devices using electric motors and balancing the attitude of the aircraft by electrically powering and modulating power to thrust devices and for short or vertical landing for as long as capacitors can supply power, boosting the lift for shorter landing.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

We claim:

1. A propulsion system for a vehicle, comprising:
at least one generator;
at least one ultracapacitor coupled to the at least one generator;
at least one battery coupled to the at least one generator;
at least one compressor coupled to the at least one generator, the at least one ultracapacitor and the at least one battery; and
at least one propulsive element coupled to the compressor.

2. The system of claim 1, wherein the at least one propulsive element comprises a propeller.

3. The system of claim 1, wherein the at least one ultracapacitor supplies power for a predetermined period of time and then recharges from the at least one generator.

4. The system of claim 1, wherein the vehicle comprises at least one wing and the at least one propulsive element is coupled to the at least one wing.
